(19) United States
(12) Patent Application Publication
(10) Pub. No.: US 2003/0200772 A1
(43) Pub. Date: Oct. 30, 2003

(54) Methods and apparatus for forming optical fiber

(76) Inventors: John D. Foster, Wilmington, NC (US); Daniel W. Hawtof, Corning, NY (US); Claude E. Lacy, Painted Post, NY (US); Daniel Mieczkowski, Corning, NY (US); Ying Lisa Peng, Big Flats, NY (US); Dale R. Powers, Painted Post, NY (US); Richard A. Quinn, Horseheads, NY (US); Jennifer L. Tarplee, Wilmington, NC (US); Wanda J. Walczak, Big Flats, NY (US)

Correspondence Address: CORNING INCORPORATED, SP-TI-3-1, CORNING, NY, 14831

(21) Appl. No.: 10/136,697

(22) Filed: Apr. 30, 2002

(51) Int. Cl. C03B 37/018

(52) U.S. Cl. 65/424; 65/434; 65/507

(57) ABSTRACT

A method for forming a doped optical fiber includes drawing the optical fiber from a doped glass supply at a draw speed and a draw tension sufficient to introduce a heat aging defect in the optical fiber. The optical fiber is treated by maintaining the optical fiber within a treatment temperature range for a treatment time while preferably maintaining the optical fiber within a treatment tension range to reduce the tendency of the optical fiber to increase in attenuation over time following formation of the optical fiber. Apparatus are also provided.

### FIELD OF THE INVENTION

The present invention relates to methods and apparatus for forming optical fiber and, more particularly, to methods and apparatus for forming optical fiber having improved characteristics.

### BACKGROUND OF THE INVENTION

Attenuation and sensitivity to heat (or thermal) aging may be critical attributes of optical fibers, particularly for high data rate optical fibers. In making optical fibers, it may be necessary or desirable to minimize attenuation loss in the intended window of operation for the fiber. Attenuation in an optical fiber can increase after fabrication of the fiber because of a phenomenon called “heat aging.” Heat aging is the tendency of some optical fibers to increase in attenuation over time following formation of the fibers due to temperature fluctuations in the fiber's environment. Typically, the attenuation change from heat aging may be apparent at approximately 1200 nanometers (nm) with increasing effect up to about 1700 nm in a spectral attenuation plot.

### SUMMARY OF THE INVENTION

Embodiments of the present invention provide methods and apparatus for forming an optical fiber, such as a doped optical fiber. As optical fiber is drawn from an optical fiber preform at certain draw speeds and draw tensions, undesirable heat aging defects are induced into the optical fiber. To combat these defects, the optical fiber is treated in accordance with the invention by maintaining the optical fiber within a treatment temperature range for a treatment time. In particular, it is desired to subject the optical fiber, as drawn, to a specified cooling rate. This phenomena of heat aging is best minimized by performing slowed cooling, preferably, while maintaining the optical fiber within a treatment tension range. Thus, advantageously, the invention herein reduces the tendency of the optical fiber to increase in attenuation over time following formation of the optical fiber, i.e., it reduces the so-called heat aging effect.

The glass preform, and thus the optical fiber, may be doped with a dopant selected from the group consisting of germanium, fluorine, phosphorous, chlorine or combinations thereof. In particular, certain fiber refractive index profiles are found by the inventors to be more susceptible to heat aging, for example, fibers with high amounts of dopants are found to be very susceptible.

In the various embodiments, the optical fiber is drawn from a draw furnace apparatus. In one embodiment, the drawn optical fiber is passed through a treatment furnace. The treatment furnace is preferably disposed substantially immediately downstream from the draw furnace. Most preferably, the treatment furnace is attached directly to the end of the draw furnace at a location where the fiber exits therefrom such that a seal is preferably formed therebetween. This minimizes unwanted entry of air into the draw furnace.

In further embodiments, the optical fiber is drawn from a draw furnace such that the drawn fiber is initially surrounded by a first gas. The drawn optical fiber may be treated by passing the drawn optical fiber through a passage or chamber of a passive muffle (lacking an active heating element). The passage or chamber preferably contains a second gas having a lower thermal conductivity than the first gas. Preferably, the gases mix and are discharged out of the end of the passive muffle.

According to one embodiment of the invention, the cooling rate of the fiber within the chamber containing the second gas is controlled thereby minimizing the induced heat aging effect. It has been found that a cooling rate of between 840° C./s and 4000° C./s between the temperature range of between about 1100° C. to about 1500° C. is desirable for controlling heat aging of the fiber.

According to other embodiments of the present invention, methods are provided for treating an optical fiber following being drawn. In particular, the treatment advantageously reduces the heat aging effect where the fiber has been formed under such conditions where attenuation thereof tends to increase over time following optical fiber formation. The optical fiber is treated by maintaining the optical fiber within a treatment temperature range for a treatment time while maintaining the optical fiber within a treatment tension range to reduce the tendency of the optical fiber to increase its attenuation over time following formation of the optical fiber.

According to further embodiments of the present invention, apparatus are provided for manufacturing an optical fiber having reduced heat aging defect. In one embodiment, a draw furnace contains a doped glass preform from which the optical fiber can be drawn at a draw speed and a draw tension sufficient to introduce a heat aging defect in the optical fiber. A treatment device is positioned downstream of the draw furnace. The treatment device is operative to treat the optical fiber by maintaining the optical fiber within a treatment temperature range for a treatment time while maintaining the optical fiber within a treatment tension range to reduce the tendency of the optical fiber to increase in attenuation over time after the optical fiber has been formed.

According to further embodiments of the present invention, apparatus are provided for forming and treating an optical fiber. A draw furnace includes an exit wall and is adapted to form the optical fiber such that the optical fiber exits the draw furnace at the exit wall. A treatment furnace is secured to the draw furnace housing adjacent the exit wall and defines a passage therein. The treatment furnace is configured and positioned such that the optical fiber enters the passage as it exits the draw furnace. Preferably the passage and all passages through which the fiber passes have a minimum dimension of 12 mm such that the gob may drop therethrough.

According to further embodiments of the present invention, apparatus are provided for forming and treating an optical fiber. A draw furnace includes an exit wall and is adapted to form the optical fiber such that the optical fiber exits the draw furnace and the exit wall. The draw furnace contains a first gas, such as Helium, for example. A passive muffle (see definition below) is disposed adjacent the draw furnace and defines a passage. The passage contains a second gas having a lower thermal conductivity than the first gas, such as Argon, for example. The passive muffle is joined to the exit wall such that ambient air cannot enter the draw furnace or the passive muffle at the joinder therebetween. The first and second gasses mix in the passive muffle and exit at an end thereof.

Further features and advantages of the present invention will be appreciated by those of ordinary skill in the art from a reading of the figures and the detailed description of the preferred embodiments which follow, such description being merely illustrative of the present invention.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a block diagram illustrating methods, according to embodiments of the present invention, for manufacturing optical fiber.

FIG. 2 is a schematic, cross-sectional side view of an optical fiber forming apparatus according to embodiments of the present invention.

FIG. 3 is a schematic, cross-sectional side view of an optical fiber forming apparatus according to further embodiments of the present invention.

FIG. 4 is a schematic, cross-sectional side view of an optical fiber forming apparatus according to further embodiments of the present invention.

FIGS. 5-7 are refractive index plots of delta (%) versus radius (μm) of several optical fibers formed according to the present invention.

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers used herein refer to like elements throughout. In the figures, layers, components or regions may be exaggerated for clarity.

The present invention includes methods for treating and for forming and treating drawn optical fibers to reduce the heat aging sensitivity (defects) of the treated optical fibers. As used herein, “heat aging” means a defect in the optical fiber that causes attenuation in the fiber to increase over time subsequent to the initial formation of the fiber. As will be better understood from the description that follows, the methods and apparatus of the present invention may allow for relatively high speed, high tension formation of drawn, doped, optical glass fibers having reduced heat aging sensitivity as compared to like fibers which have been drawn at such speeds and tensions but without the treatment step of the present invention.

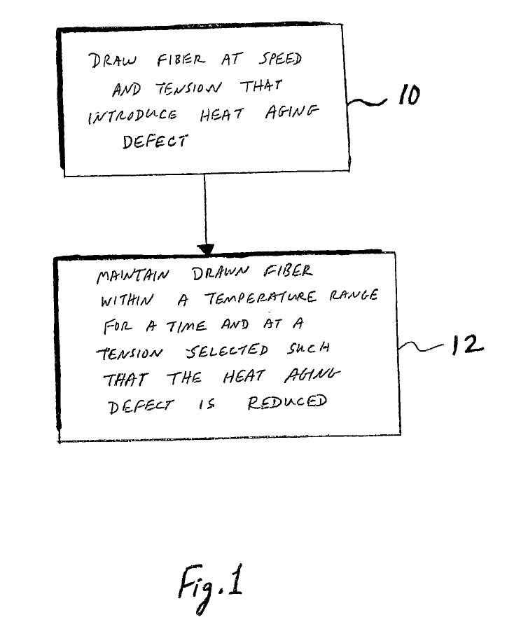

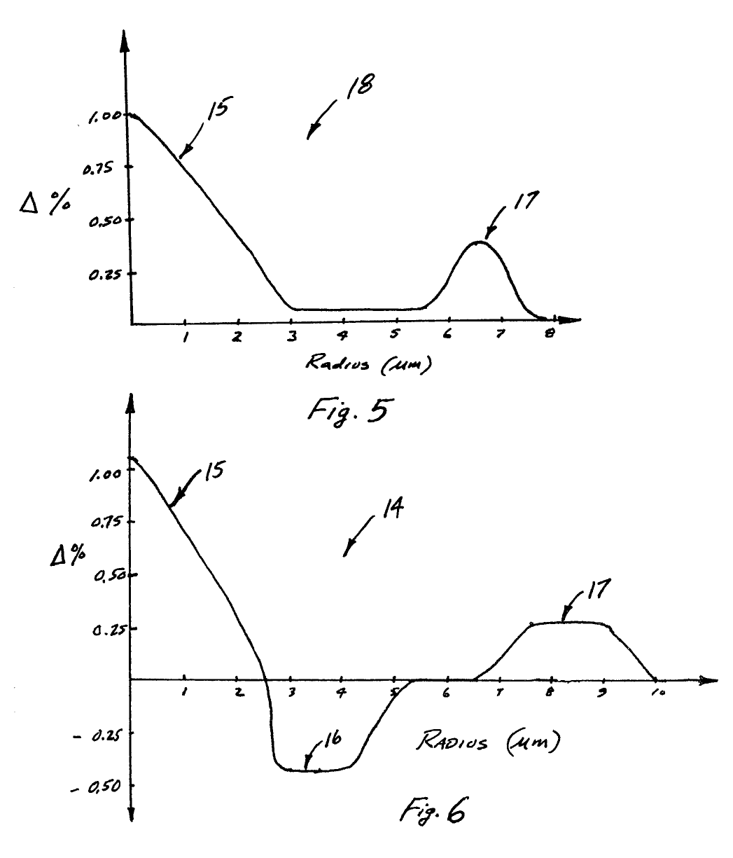

With reference to FIG. 1, in accordance with method embodiments of the present invention, an optical fiber is drawn, for example, from a suitable doped glass blank or preform, at a selected speed S_{D} and a selected tension F_{D} that is sufficient to introduce a heat aging defect in the drawn optical fiber (Block 10). Either or both of the core and the cladding (if any) of the drawn fiber may be doped. Typically, the core is doped and may include multiple segments therein, i.e., include a segmented core structure. FIGS. 5-7 illustrate delta (%) versus radius (μm) for several fiber refractive index profiles that appear to be sensitive to heat aging and which benefit from being formed and treated in accordance with the present invention. The draw speed S_{D} is preferably maintained between about 2 m/s and 35 m/s during draw. More preferably, the draw speed S_{D} is between about 6 m/s and 25 m/s. Draw speeds S_{D} of greater than about 6 m/s induce some defect for most Dispersion Compensating (DC) fibers, for example, although, in some fibers, the defect may occur for draw speeds as low as 2 m/s or more. The draw tension F_{D} is preferably in the range of between about 25 grams and 200 grams, and more preferably, in the range of between about 90 grams and 200 grams. It has been found that heat aging is typically induced in doped fibers, such as DC fibers, that are drawn at a draw speed of greater than about 6 m/s while being maintained at a draw tension of greater than 90 grams.

It should be noted that in some cases, it is possible to decrease the heat aging effect by operating with different draw conditions, such as operating at a lower draw speed or at a higher draw tension. However, some of these conditions are undesirable for either economic reasons or because the fiber attributes would be undesirable. The present invention allows the production of optical fiber more economically, and with better attributes such as strength, attenuation and uniformity while still producing an optical fiber with less attenuation increase due to heat aging in comparison to untreated optical fibers.

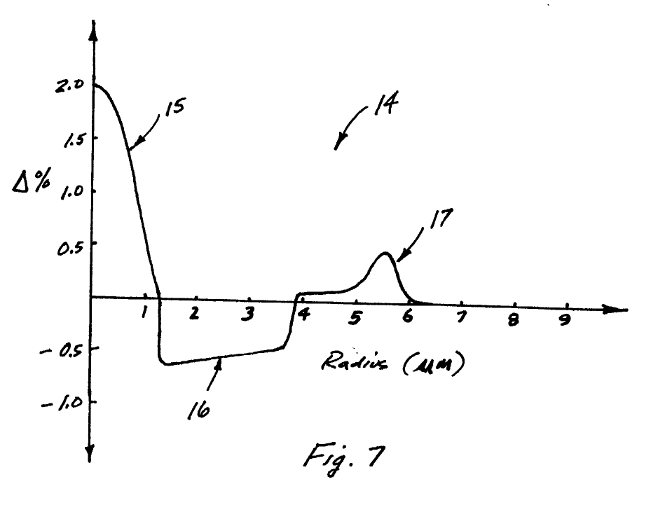

As is shown in FIGS. 6 and 7, such DC fibers 14 typically have a core including a central core 15, a moat 16 and a ring 17. The central core 15 and ring 16 typically include germania doping, while the moat typically includes fluorine doping. The delta values for the core 15 are typically greater than 0.8% and preferably range between about 0.8 to 3.0%, whereas the deltas of the rings 17 are typically greater than 0.2% and preferably range from between about 0.2 to 1.0% for such DC fibers 14. The deltas of the moats 16 are typically less than −0.2% and preferably range from between about −0.2 to −1.0%. Other fiber types, such as fiber 18 shown in FIG. 5 are also sensitive to heat aging and may include a core 15 and a ring 17.

The heat aging defect induced in the foregoing manner may be detected and measured by the following heat aging test method. First, the drawn fiber is cooled to about 20° C. and thereafter the fiber is heat cycled. The fiber is heat cycled by maintaining the drawn fiber at 200° C. for 20 hours and then cooling the fiber back to 20° C. The attenuation of the drawn fiber is thereafter measured (e.g., using an optical bench such as a PK 2500 spectral bench available from Photon Kinetics or an Optical Time Domain Reflectometer (OTDR) apparatus) at the wavelength of interest (typically between 1000 nm-1700 nm). The fiber, when drawn (Block 10) and measured in this manner, exhibits an attenuation in the wavelength of interest that is increased by at least 0.03 dB/km to 0.25 dB/km or more in the heat cycled fiber as compared to the cooled fiber prior to heat cycling (un-heat aged fiber) when measured at 1550 nm. Thus, it should be recognized that it is highly desirable to reduce the heat aging effect by treating the fiber in accordance with the invention thereby minimizing any undesirable increase in attenuation.

In order to combat the aforementioned heat aging defect, the temperature T_{T} of the drawn fiber is maintained within a selected temperature range T₁ to T₂ for a selected time t_{T} and preferably at a selected tension F_{T} (Block 12). Typically, the draw tension F_{D} is the same as the treatment tension F_{T}. In this manner, the heat aging defect present in the drawn fiber prior to the treatment step may be reduced significantly or may even be effectively eliminated.

The foregoing method may be better appreciated from the more detailed description that follows. Suitable and preferred materials and parameters for executing the foregoing steps are set forth below. Additionally, apparatus according to the present invention for conducting the foregoing and other methods are described hereinbelow.

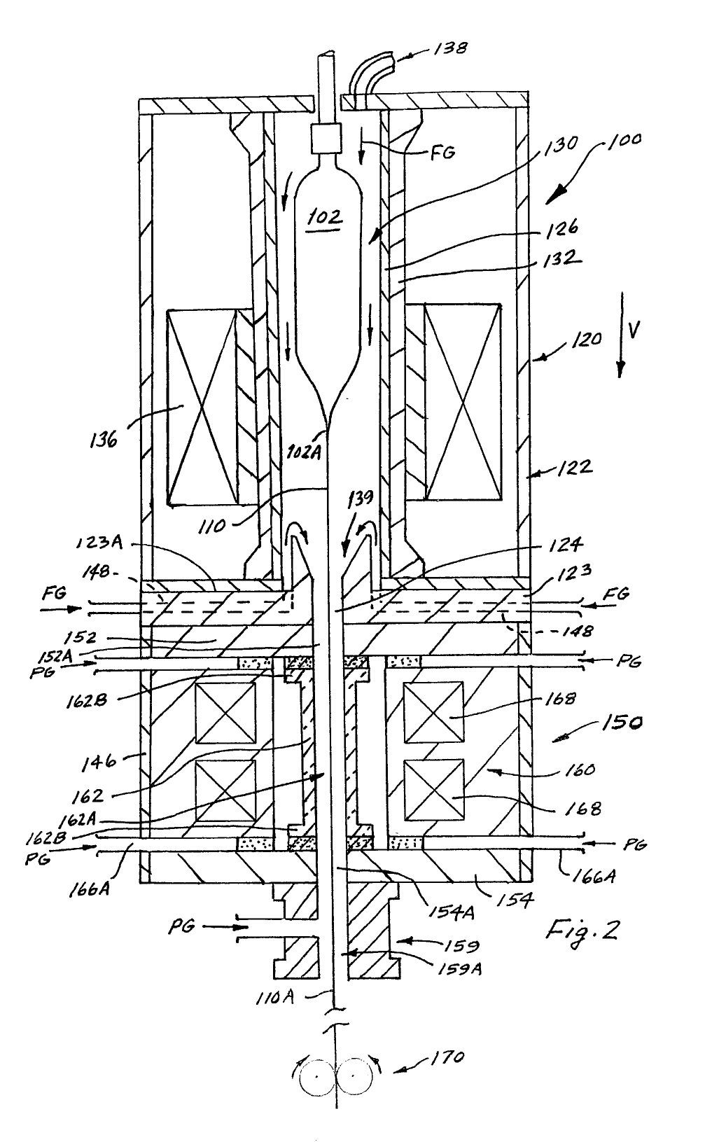

With reference to FIG. 2, an optical fiber forming apparatus 100 according to embodiments of the present invention is shown therein. The apparatus 100 includes, generally, a draw furnace 120, a treatment furnace 150 and a tensioning station 170, shown as a tractor assembly, for applying tension to the drawn fiber. The apparatus 100 may be used to form a treated optical fiber 110A from a doped glass preform 102, for example. More particularly, the draw furnace 120 may be used to form a drawn optical fiber strand 110 (hereinafter “the drawn fiber 110”) and the treatment furnace 150 may thereafter be used to treat the drawn fiber 110 to form a treated optical fiber strand 110A (hereinafter “the treated fiber 110A”). The treated optical fiber 110A being treated so as to minimize the heat aging effect. The tensioning station 170 serves to control and maintain the desired tension in the fiber 110, 110A. Additional conventional process steps may be included, such as non-contact diameter measurement apparatus, further fiber cooling apparatus, fiber coating and curing apparatus for applying and curing the primary and secondary fiber coatings, and spool winding apparatus. Such additional process steps are conventional and not shown for clarity. Additionally, an iris or moveable door mechanism may be employed at the bottom of the treatment furnace to minimize the amount of air entry into the treatment furnace.

The glass preform 102 is preferably formed of a doped silica glass. The preform 102 may be formed such that either the core or the cladding (if present) of the drawn fiber is doped, or such that both the core and the cladding of the drawn fiber are doped. The silica glass may be doped with one or more of germanium, fluorine, phosphorous or chlorine, or combinations thereof, for example. Other suitable dopants may be used as well. Germanium doped fibers, such as shown in FIGS. 5-7, were found by the inventors to exhibit heat aging under most manufacturing conditions. Methods and apparatus for forming the preform 102 are well known and are readily appreciated by those of skill in the art. Such methods include IVD, VAD, MCVD, OVD, PCVD and the like.

The draw furnace 120 preferably includes a housing 122 surrounding the preform and having a flange 123 secured on the lower end thereof, the flange 123 serving as the exit wall of the draw furnace 120. An axial opening 124 is defined in the flange 123 through which the fiber 110 passes and through which the previously dropped glass gob may pass. An annular sleeve-like susceptor 126 (which may be, for example, formed of graphite) extends through the draw furnace 120 and defines a passage 130 therein. The passage 130 includes an upper section adapted to receive and hold the optical fiber preform 102 and a lower section through which the drawn fiber 110 passes as glass is melted and drawn off from the preform 102. The gob, formed at the initiation of drawing also passes through this section. The lower section of the passage 130 communicates with the opening 124. A hollow exit cone 139 is preferably positioned over the opening 124. An annular insulator 132 and an induction coil(s) 136 surround the susceptor 126.

A suitable inert forming gas FG, most preferably helium, is introduced into the passage 130 at about 1 atmosphere of pressure through a suitable flow inlet 138 and flows downwardly and out of the draw furnace 120 through the opening 124. The draw furnace 120, as described and illustrated, is merely exemplary of suitable draw furnaces and it will be appreciated by those of skill in the art that draw furnaces of other designs and constructions, for example, using other types of heating mechanisms, susceptors and insulation, etc. may be employed.

With reference again to FIG. 2, opposed flow passages 148 extend radially through the flange 123 and terminate in openings at the upper surface 123A thereof. The passages 148 also extend vertically through the flange 123 and terminate adjacent the outer periphery of the cone 139. Forming gas FG is additionally fed through the openings of the passages 148 and flows up around the cone 139 and back down through the center opening of the cone 139. The forming gas FG may be, for example, helium gas (He), nitrogen gas (N₂), Argon gas (Ar), or any other suitable inert gas. Most preferably, the forming gas FG is helium gas.

The treatment furnace 150 is positioned below, and preferably interconnected to, the flange 123. The treatment furnace 150 includes a heating unit 160 with one or more annular heating elements 168 therein. The heating element may be, for example, an electrical resistance or an induction heating coil. Openings 152A and 154A are defined in the upper and lower ends of treatment furnace 152 and 154, respectively. The openings along the draw path are sufficiently large to enable the glass gob to drop through upon initiation of draw. The ends 152, 154 and the sleeve 146 serve as the housing for the treatment furnace 150. However, it will be appreciated that other housing configurations and components may be employed. The treatment furnace 150 is preferably secured to flange 123 of the draw furnace 120 by suitable means such as fasteners.

A generally cylindrical quartz spool 162 is disposed in the heating unit 160. The spool 162 defines a passage 162A and has a pair of quartz flanges 162B located on opposed ends thereof. The flanges 162B may be, for example, flame welded to the ends of a quartz tube to form the spool 162. A first graphite gasket 164 is interposed between the lower surface of the flange 152 and the upper flange 162B. A second graphite gasket 164 is interposed between the lower flange 154 and the lower flange 162B.

Gas rings 166 having feed passages 166A surround the graphite gaskets 164 and have small perforations adapted to direct a purge gas PG toward the graphite gaskets 164. The purge gas PG is provided to reduce or prevent exposure of the graphite gaskets 164 to air and may be, for example, helium (He), Argon (Ar), nitrogen (N₂), or any other suitable inert gas.

A purge gas member 159 is affixed to the lower surface of the flange 154. A purge gas PG is pumped into the purge tube passage 159A to prevent air from entering the passage 162A from below.

The passage 162A of the quartz tube 162 preferably has a diameter dimension D of greater than 12 mm at all places along its length, and preferably between about 12 mm and 80 mm, and more preferably between 45 mm and 80 mm to allow the glass gob formed at the initiation of drawing to readily drop therethrough. The length L of the treatment zone of the treatment furnace 150 extending between the upper surface of the flange 152 and the lower surface of the flange 154 is preferably between about 0.2 m and 3 m, and more preferably between 0.5 m and 1.0 m. The preferred length L will depend on the draw speed of the fiber 110 and the preferred ranges above are for a draw speed of from about 2 m/s to 35 m/s, and more preferably between 6 m/s and 25 m/s.

The tensioning station 170 may be any suitable device for controlling the tension in the drawn fiber 110. Preferably, the tensioning device 170 includes a microprocessor which continuously receives input from one or more fiber tension and/or diameter sensors (not shown) and is operative to apply the tension of the fiber 110 as needed. In a preferred embodiment, the tension commanded is based upon controlling the diameter to equal a set diameter stored in memory.

The apparatus 100 may be used in the following manner to manufacture a treated optical fiber 110A. The furnace induction coil 136 is operated to heat the tip 102A of the optical fiber preform 102 to a preselected draw temperature T_{D}. Preferably, the draw temperature T_{D} is in the range of between about 1800° C. and 2200° C. More preferably, the draw temperature T_{D} is in the range of between about 1900° C. and 2050° C. The preform tip 102A is maintained at the selected draw temperature T_{D} so that the drawn fiber 110 is continuously drawn off of the tip 102A in a draw direction V, which is preferably vertically downward. The fiber 110 is maintained at a calculated draw tension F_{D} as described above by the tensioning device 170 or other suitable tension applying apparatus such that the set diameter (typically 125 μm) of the fiber is met within a predefined tolerance band. The forming gas FG (e.g., helium) is pumped from the upper inlet 138 and through the passages 130, 124, 152A, 162A, 154A and out through the purge tube passage 159A.

In this way, the drawn fiber 110 is drawn off from the preform 102 at a selected draw speed S_{D} as described above. The selected draw temperature T_{D} and the draw tension F_{D} used to manufacture the fiber causes the fiber 110 to have the undesirable heat aging defect. That is, as a result of the draw temperature T_{D} and the draw tension F_{D} used to draw the fiber 110 at the desired speed S_{D} , the drawn fiber 110 will exhibit a sensitivity to heat aging.

Because the treatment device 150 is secured substantially immediately adjacent the opening 124 of the draw furnace 120, the drawn fiber 110 is not quenched by cooler ambient air as the fiber 110 exits the draw furnace 120. Further, the possibility of oxygen getting into the draw furnace is reduced, thereby minimizing possible degradation of the graphite susceptor 126. In the present invention, the drawn fiber 110 passes through the passage 124 and is substantially immediately heated by the heating unit 160. The heating unit 160 maintains the temperature of the fiber 110 at a treatment temperature T_{T} within a selected temperature range T₁ to T₂. The lower temperature T₁ is preferably between about 1100° C. and 1400° C. and the upper temperature T₂ is preferably between about 1200° C. and 1800° C. More preferably, the lower temperature T₁ is between about 1200° C. and 1350° C. and the upper temperature T₂ is between about 1300° C. and 1450° C. Also, as the fiber 110 passes through the passage 162A, the fiber 110 is maintained at a selected treatment tension F_{T}. Preferably, the treatment tension F_{T} is between about 25 and 200 grams. More preferably, the treatment tension F_{T} is between about 90 and 170 grams. The length L of the treatment zone is selected such that the drawn fiber 110 is maintained within the selected temperature range T₁ to T₂ for a selected resident treatment time t_{T}. The treated fiber 110A exits the treatment furnace 150 through the bottom opening 154A and preferably continues downwardly to additional processing stations (additional cooling, measurement, coating, etc.).

The above-described treatment temperature T_{T}, treatment tension F_{T} and resident time t_{T} are cooperatively selected to reduce or eliminate the heat aging defect or sensitivity in the fiber 110. Accordingly, the treated fiber 110A so formed will have a lesser heat aging defect or sensitivity as compared to an optical fiber 110 which has not been suitably treated in the manner described above (i.e., using the step of Block 12 in FIG. 1), but which has otherwise been formed in the same manner. The foregoing methods and apparatus thus allow for relatively high speed drawing of optical fiber with reduced heat aging defects as compared to untreated fibers drawn at the same speed.

Preferably, the draw furnace 120 and the treatment furnace 150 are relatively configured and secured and the gases are supplied such that they provide an air-tight path from the passage 130 to the opening 159A.

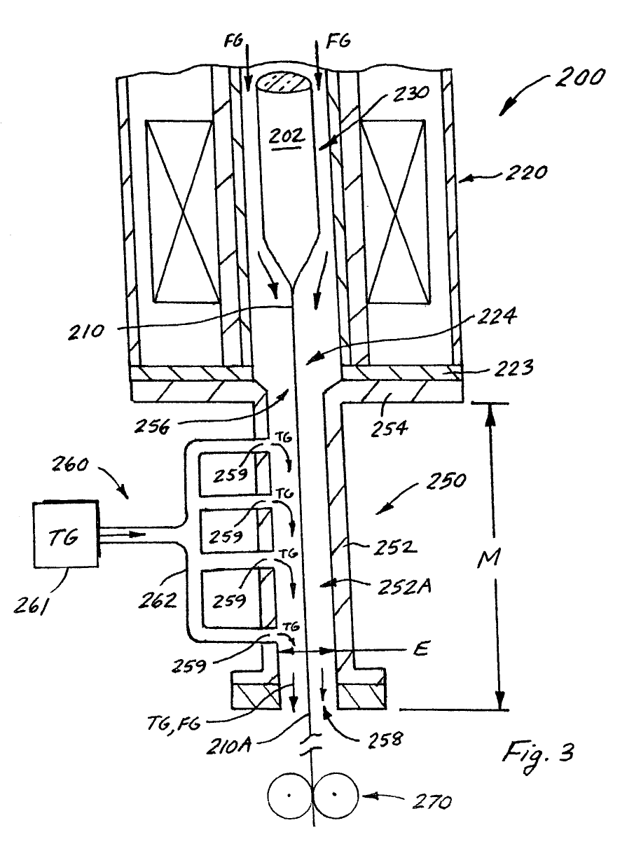

With reference to FIG. 3, an optical fiber forming apparatus 200 according to further embodiments of the present invention is shown. The apparatus 200 includes a draw furnace 220 corresponding to the draw furnace 120. In place of the treatment furnace 150, the apparatus 200 includes a passive treatment assembly 250. The assembly 250 is “passive” in that it does not include a heating device corresponding to the heating module 160 in any portion thereof. In other words, the fiber is cooled at a controlled rate without the aid of an active heating module.

The apparatus 200 includes a draw furnace 220 and a tensioning station 270 corresponding to the draw furnace 120 and the tensioning station 170, respectively. Preferably, the draw furnace 220 is of the type having a graphite susceptor. The passive treatment assembly 250 includes a tubular muffle 252 having an upper flange 254. The muffle 252 is affixed directly to the lower end wall 223 of the furnace 220 by bolts or other fasteners (not shown for clarity) that extend through holes in the flange 254 and engage the end wall 223. The muffle 252 is preferably formed of metal, such as stainless steel or aluminum.

The muffle 252 defines an upper opening 256 at a first end, an opposing lower opening 258 at a second end and a passage 252A extending therebetween. Preferably, the diameter E of the passage 252A is substantially uniform and greater than 12 mm, more preferably between about 12 mm and 80 mm, and most preferably between 45 and 80 mm. The upper opening 256 communicates with the lower opening 224 of the draw furnace 220. A plurality of axially spaced supply ports 259 are formed in the side wall of the muffle 252 and communicate with the passage 252A along its length.

A treatment gas flow system 260 is operatively and fluidly connected to the muffle 252. The treatment gas flow system 260 includes a treatment gas supply 261 that is fluidly and operatively connected to each of the ports 259 by a manifold or conduits 262. The treatment gas supply station 261 includes a supply of a selected treatment gas TG, and a pump or the like operative to pressurize the treatment gas TG sufficiently to force it through the conduits 262 and the feed ports 259 and into the passage 252A. The treatment gas supply station 261 may optionally include a heating unit to heat the treatment gas TG. However, preferably the treatment gas is supplied at 20° C.

The apparatus 200 may be used in the following manner to form a treated optical fiber 210A. Using the draw furnace 220 and the tensioning device 270, a fiber 210 corresponding to the fiber 110 is drawn from a preform 202 corresponding to the preform 102 in the manner described above with regard to the apparatus 100, at a draw temperature and a draw tension sufficient to introduce a heat aging defect. As the fiber 110 is being drawn, a forming gas FG is introduced through an inlet identical to that shown in FIG. 2. The forming gas flows through the passage 230 about the preform 202 and the fiber 210, through the opening 224 in the furnace end wall 223 and into the first end of the passage 252A through the opening 256.

The drawn fiber 210 enters the passage 252A of the muffle 252 immediately upon exiting the furnace 220. As the fiber 210 passes through the passage 252A, the treatment gas TG is pumped from the treatment gas supply 261 into the passage 252A through the at least two axially spaced supply ports 259 as indicated by the arrows in FIG. 3. The treatment gas flows into the passage 252A at the various stages and mixes with the forming gas FG. Preferably, the treatment gas TG has a thermal conductivity k of less than about 120×10⁻⁶ cal/(sec) (cm)² (° C./cm), and more preferably less than about 65×10⁻⁶ cal/(sec) (cm)² (° C./cm) at 25° C. The mixture of the treatment gas TG and the forming gas FG flows through the passage 252A and exits through the second end opening 258.

The treatment gas TG has a lower thermal conductivity than the forming gas FG. Preferably, the thermal conductivity of the treatment gas TG is less than 40% of, and more preferably less than 20% of, the thermal conductivity of the forming gas FG. The treatment gas TG is preferably nitrogen or argon. More preferably, the treatment gas TG is argon. The forming gas FG is preferably helium.

As the drawn fiber 210 is drawn through passage 252A, the drawn fiber 210 is maintained at the selected treatment tension F_{T}, and the treatment temperature T_{T} of the fiber 210 while in the passage 252A is maintained in the selected temperature range T₁-T₂ for the selected residence time t_{T} as discussed above with respect to the apparatus 100. In the manner described above with respect to the apparatus 100, the selected treatment tension F_{T}, temperature range T₁ to T₂ and residence time t_{T} are cooperatively selected such that they reduce or eliminate the heat aging defect in the fiber 210, thereby providing a treated fiber 210A corresponding to the treated fiber 110A. In the case of the apparatus 200, the length M of the passage 252A of the passive treatment device 250 is selected to provide the desired residence time t_{T} in view of the draw speed of the fiber 210.

The lower thermal conductivity of the treatment gas TG slows heat transfer from or cooling of the drawn fiber 210 so that the fiber 210 is maintained in the selected temperature range T₁-T₂ while in the passage 252A. The flow rate, turbulence and temperature of the treatment gas TG may be selected as appropriate to provide the desired cooling rate. In accordance with this embodiment of the invention, the desired cooling rate in the treatment furnace 250 is between 2500° C./sec and 3500° C./sec in a temperature range of between 1200° C. to 1500° C.

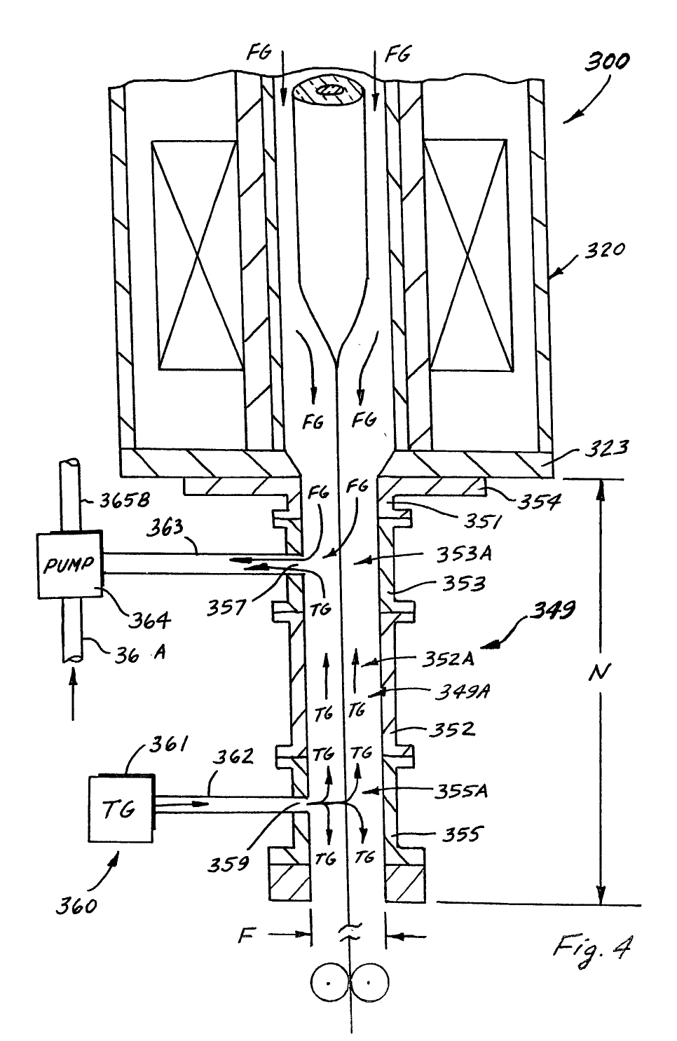

With reference to FIG. 4, an optical fiber forming apparatus 300 according to further embodiments of the present invention is shown therein. The apparatus 300 includes a draw furnace 320 of the type having a graphite susceptor. The apparatus 300 corresponds to the apparatus 200 except as follows and may be used in the same manner except as follows.

The muffle 250 is replaced with a multi-piece muffle assembly 349 defining a continuous passage 349A. The muffle assembly 349 includes an annular upper muffle section 351 including a flange 354 for securing the muffle assembly 349 to the exit wall 323 of the draw furnace 320. A second annular muffle section 353 is affixed to the lower end of the muffle section 351 and defines a passage 353A. An outlet port 357 is formed in the side of the muffle 353 and communicates with the passage 353A. A third annular muffle section 352 is affixed to the lower end of the muffle section 353 and defines a passage 352A. A fourth annular muffle section 355 is fixed to the lower end of the muffle section 352 and defines a passage 355A. A feed port 359 is formed in the muffle 355 and communicates with the passage 355A. The diameter F of the passage 349A is preferably substantially uniform and preferably greater than 12 mm, more preferably between about 12 mm and 80 mm, and most preferably between 45 and 80 mm and is preferably of substantially constant diameter along its length N. The length N of the muffle assembly 349 is preferably between about 0.2 m and 1.0 m.

Additionally, in the apparatus 300, the treatment gas flow apparatus 260 is replaced with a treatment gas flow system 360. The flow system 360 includes a treatment gas supply 361 corresponding to the treatment gas supply station 261. The treatment gas supply station 361 is fluidly connected to the feed port 359 by a conduit 362. The flow system 360 further includes a pump 364 fluidly connected to the outlet port 357 by a conduit 363. The pump 364 is preferably a Venturi pump that is provided with a supply of compressed air from inlet 365A as illustrated.

In use, the treatment gas TG is introduced from the treatment gas supply 361 through the conduit 362 and the feed port 359 into the passage 355A. The pump 364 provides a sufficient vacuum and resultantly draws at least a portion of the treatment gas TG up through the passages 352A and 353A, through the outlet port 357 and the conduit 363, and out through an outlet 365B. Simultaneously, the vacuum generated by the pump 364 draws the forming gas FG from the draw furnace 320 through the passage 353A, the outlet port 357 and the conduit 363, and out through the pump outlet 365B as well. This is beneficial, because it prevents the mixing of the two gasses in the lower end of the passage 349A.

### EXAMPLE 1

Using a draw furnace, a negative dispersion germania-doped optical fiber having a profile including a core and a ring as shown in FIG. 5 was drawn from a doped preform at a rate of 14 meters per second (m/s) with a tension of 150 grams. Thereafter, the fiber was cooled to 20° C. and then subjected to the heat aging test as described above. Following this test, the measured attenuation increase in the untreated fiber at 1550 nm was 0.0830 dB/km.

A second fiber was drawn from an identical preform in the same manner as described just above. The second fiber was passed through a treatment apparatus in accordance with the invention as described in FIG. 4 immediately after the fiber exited the draw furnace. The length and operating parameters of the treatment furnace were selected such that the temperature of the second fiber was maintained at a desired temperature for a desired amount of time. In particular, the length M of passage was about 0.615 m. Thus, the fiber was maintained at a temperature of from about 1700° C. to about 1525° C. for a residence time of about 0.044 seconds while the tension in the fiber was maintained at 150 grams. The forming gas FG was helium and the treatment gas TG was argon at 23° C. Thereafter, the fiber was cooled to 20° C. and then subjected to the same heat aging testing as heretofore described. The measured attenuation in the fiber subjected to the treatment increased only 0.027 dB/km at 1550 nm. Thus, for this fiber type as shown in FIG. 5, a 67% reduction in the heat aging was obtained by subjecting the fiber to the additional treatment step in accordance with the invention.

### EXAMPLE 2

Using a draw furnace, a negative dispersion germania and fluorine doped optical fiber having a profile including a core, moat and a ring as shown in FIG. 6 was drawn from a preform at a rate of 14 meters per second (m/s) with a tension of 150 grams. Thereafter, the fiber was cooled to 20° C. and then subjected to the heat aging test as described above. Then testing revealed that the measured attenuation increase in the fiber at 1550 nm was 0.285 dB/km following heating for 20 hours at 200° C.

A second fiber was drawn from an identical preform in the same manner as described just above. The second fiber was subjected to the treatment apparatus and method in accordance with the invention described in FIG. 4 herein immediately after the fiber exited the draw furnace. The length and operating parameters of the treatment furnace were selected such that the temperature of the second fiber was maintained at the conditions identified in Example 1. Thereafter, the fiber was cooled to 20° C. and then subjected to the same heat aging testing as heretofore described. The measured attenuation increase in the fiber subjected to the treatment was only about 0.033 dB/km at 1550 nm. Thus, for this fiber type, a dispersion compensating fiber having a positive delta core, a negative delta moat and a positive delta ring, it should be recognized that a dramatic reduction (88%) in the heat aging was obtained by subjecting the fiber to the additional treatment step. The cooling rate applied in the previous two examples was approximately 3980° C./s.

### EXAMPLE 3

Using a draw furnace, a germania and fluorine doped silica glass optical fiber having a negative dispersion and dispersion slope and a profile as shown in FIG. 5 was drawn from a preform at a rate of 14 meters per second (m/s) with a tension of 150 grams. A helium forming gas was used in the draw furnace. Thereafter, the fiber was cooled to 20° C. and then subjected to the heat aging testing where the fiber is maintained at 200° C. for 20 hours. At the end of this period, the fiber was cooled to 20° C., the measured attenuation increase in the fiber at 1550 nm was 0.420 dB/km.

A second fiber was drawn in the same manner as described just above from an identical fiber. The second fiber was passed through a heated treatment apparatus as shown in FIG. 2 immediately after the fiber exited the draw furnace. The length of the muffle was 0.4 m and its inside diameter was 60 mm and the temperature was selected such that the temperature of the second fiber was maintained at from about 1700° C. to about 1525° C. for a residence time of about 0.028 seconds while the tension in the fiber was maintained at 150 grams. The second fiber was heat aging tested as before and the measured attenuation increase in the fiber at 1550 nm was 0.0015 dB/km. Thus, the present invention resulted in a 96% reduction in heat aging.

Other actual experimental examples are illustrated in Table 1. Listed are the Example Number (Ex.), the attenuation change with (With Treat) and without (W/O Treat) the heat aging reduction treatment, the % reduction in heat aging when treated (% Red.), the fiber profile (Prof.) of the fiber treated, the dopants present in the treated fiber (Dop.), the draw tension used (Tens.), the draw speed used (Draw Speed), the apparatus used (App.), and whether the apparatus included a heater (Heater).

TABLE 1
illustrates the results for the various examples.

| | | W/O Treat | With Treat | % | | | Tens. | Draw | | |
|---|---|---|---|---|---|---|---|---|---|---|
| Ex. | Gas | dB/km | dB/km | Red. | Prof. | Dop. | grams | Speed m/s | App. | Heater |
| 1 | Ar | 0.083 | 0.027 | 67% | | Ge | 150 | 14 | | No |
| 2 | Ar | 0.285 | 0.033 | 88% | | Ge/F | 150 | 14 | | No |
| 3 | He | 0.420 | 0.0015 | 96% | | Ge/F | 150 | 14 | | Yes |
| 4 | He | 0.032 | 0.0155 | 52% | | Ge | 150 | 14 | | Yes |
| 5 | He | 0.191 | 0.0175 | 91% | | Ge/F | 150 | 14 | | Yes |
| 6 | He | 0.560 | 0.050 | 91% | | Ge/F | 150 | 20 | | Yes |
| 7 | Ar | 0.141 | 0.066 | 53% | | Ge | 150 | 20 | | No |
| 8 | Ar | 0.135 | 0.054 | 60% | | Ge | 150 | 17.5 | | No |
| 9 | Ar | 0.108 | 0.059 | 45% | | Ge | 150 | 15.0 | | No |
| 10 | Ar | 0.082 | 0.052 | 36% | | Ge | 150 | 12.5 | | No |
| 11 | Ar | 0.649 | 0.294 | 55% | | Ge/F | 90 | 15 | | No |
| 12 | Ar | 0.458 | 0.101 | 78% | | Ge/F | 150 | 20 | | No |

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. A method for forming an optical fiber, the method comprising:
drawing the optical fiber from a doped glass supply at a draw speed and a draw tension sufficient to introduce a heat aging defect in the optical fiber; and
treating the optical fiber by maintaining the optical fiber within a treatment temperature range for a treatment time while maintaining the optical fiber within a treatment tension range to reduce the tendency of the optical fiber to increase in attenuation following formation of the optical fiber.

2. The method of claim 1 wherein the optical fiber is doped with a germanium dopant.

3. The method of claim 2 wherein the optical fiber is doped with a dopant selected from the group consisting of fluorine, chlorine, and phosphorous.

4. The method of claim 1 wherein the treatment temperature range is between about 1100° C. to about 1500° C.

5. The method of claim 4 wherein the treatment temperature range is between about 1200° C. to about 1450° C.

6. The method of claim 1 wherein the treatment time is in the range of between about 0.025 seconds and 0.5 seconds.

7. The method of claim 6 wherein the treatment time is in the range of between about 0.03 seconds and 0.1 seconds.

8. The method of claim 1 wherein the treatment tension range is from about 25 grams to about 200 grams.

9. The method of claim 8 wherein the treatment tension range is between about 60 and 170 grams.

10. The method of claim 1 wherein the draw speed is in the range of between about 2 and 35 m/s.

11. The method of claim 10 wherein the draw speed is between about 6 and 25 m/s.

12. The method of claim 1 wherein the step of treating further comprises cooling the optical fiber at a cooling rate greater than 830° C./s and less than 4000° C./s.

13. The method of claim 1 wherein said step of treating is conducted after the step of drawing without any intervening treatment processing step.

14. The method of claim 13 wherein said step of treating is conducted substantially immediately after said step of drawing.

15. The method of claim 1 wherein:
the step of drawing includes drawing the optical fiber in a draw furnace;
the step of treating includes passing the drawn optical fiber through a treatment furnace; and
the treatment furnace is disposed substantially immediately downstream of the draw furnace and sealed to an underside of the draw furnace.

16. The method of claim 1 wherein:
the step of drawing includes drawing the optical fiber from a draw furnace such that the drawn fiber is initially surrounded by a first gas; and
the step of treating includes passing the drawn optical fiber through a passage of a passive muffle, the passage containing a second gas having a lower thermal conductivity than the first gas wherein the first and second gases mix and exit from an end of the passage of the passive muffle.

17. The method of claim 16 further comprising a step of disposing the passive muffle substantially immediately downstream of the draw furnace.

18. The method of claim 17 wherein the draw furnace and the passive muffle are relatively positioned such that ambient air cannot enter the draw furnace or the passive muffle at the joinder therebetween.

19. The method of claim 18 wherein:
the passive muffle includes an inlet adjacent the draw furnace, an outlet opposite the inlet, and a side port located between the inlet and the outlet, each of the inlet, the outlet and the side port communicating with the passage; and
the step of treating includes flowing the second gas through the side port, the passage and the outlet as the optical fiber passes through the passage.

20. The method of claim 17 wherein:
the passive muffle includes an inlet adjacent the draw furnace, an outlet opposite the inlet, an upper side port located between the inlet and the outlet, and a lower side port located between the upper side port and the outlet, each of the inlet, the outlet, the upper side port and the lower side port communicating with the passage; and
the step of treating includes flowing the second gas through the upper side port, the passage and the lower side port as the optical fiber passes through the passage.

21. The method of claim 20 wherein said step of flowing the second gas includes applying a vacuum to the upper side port to draw each of the first and second gases out through the upper side port.

22. The method of claim 17 wherein the second gas is selected from a group consisting of argon, neon, nitrogen, and oxygen.

23. An apparatus for manufacturing an optical fiber, comprising:
a draw furnace having a passage containing
an optical fiber preform from which the optical fiber can be drawn, and
a forming gas having a first thermal conductivity coefficient; and a heat aging treatment device positioned downstream of the draw furnace, the treatment device including
a treatment tube, and
a treatment gas distributor fluidly connected thereto, the gas distributor having at least two axially spaced supply ports connected to the tube at at least two axially spaced locations enabling supply of treatment gas to the tube at the at least two axially spaced locations.

24. The apparatus of claim 23 wherein the treatment device further comprises a treatment furnace surrounding the muffle tube, wherein the treatment furnace includes at least one heating element.

25. An apparatus for manufacturing an optical fiber, comprising:
a draw furnace having a passage adapted to contain an optical fiber preform from which the optical fiber can be drawn, the passage housing a first gas having a first thermal conductivity coefficient; and
a heat aging treatment device positioned downstream of the draw furnace, the treatment device includes a treatment tube and a supply of second gas connected thereto, the second gas having a lower thermal conductivity than the first gas wherein the treatment tube has a minimum dimension of at least 12 mm.

26. An apparatus for forming and treating an optical fiber, comprising:
a draw furnace including an exit wall and adapted to form the optical fiber such that the optical fiber exits the draw furnace at the exit wall, the draw furnace containing a first gas also exiting at the exit wall;
a passive muffle disposed adjacent the draw furnace having first and second ends and defining a passage, the passage containing a second gas having a lower thermal conductivity than the first gas wherein the first gas enters the passage at the first end and the first and second gases mix in the passive muffle and exit at the second end; and
wherein the passive muffle is joined to the exit wall at the first end such that ambient air cannot enter the draw furnace or the passive muffle at the joinder therebetween.

27. The apparatus of claim 26 wherein the second gas is selected from a group consisting of argon, neon, nitrogen, and oxygen.
